(19) United States
(12) Patent Application Publication
(10) Pub. No.: US 2013/0115431 A1
(43) Pub. Date: May 9, 2013

(54) INK COMPOSITION, INK JET RECORDING METHOD, AND RECORDED MATTER

(71) Applicant: Seiko Epson Corporation, Tokyo (JP)

(72) Inventors: Tetsuya AOYAMA, Shiojiri (JP); Hitoshi OHTA, Shiojiri (JP); Takeshi YANO, Shiojiri (JP)

(73) Assignee: Seiko Epson Corporation, Tokyo (JP)

(21) Appl. No.: 13/669,734

(22) Filed: Nov. 6, 2012

(30) Foreign Application Priority Data
Nov. 8, 2011 (JP) 2011-244220

(51) Int. Cl. C09D 11/10; B32B 3/10; B41J 2/01

(52) U.S. Cl. 428/195.1; 106/31.13; 347/100

(57) ABSTRACT

An ink composition includes at least a coloring material, two or more polysiloxane surfactants having different solubilities in water, and alkyl polyols having a boiling point at one atmosphere of 180 to 230° C. The ink composition does not substantially contain alkyl polyols having a boiling point at one atmosphere of 280° C. or more and enables recording on a non-ink-absorbing or low-ink-absorbing recording medium.

Priority is claimed under 35 U.S.C. §119 to Japanese Application No. 2011-244220 filed on Nov. 8, 2011, which is hereby incorporated by reference in its entirety.

### BACKGROUND

1. Technical Field

The present invention relates to an ink composition, an ink jet recording method, and a recorded matter.

2. Related Art

An ink jet recording method that records images and letters by discharging minute ink droplets from nozzles of an ink jet recording head has been mainly employed in recording on surfaces of ink-absorbing recording media such as paper. Ink compositions widely used in such an ink jet recording method contain various coloring materials such as dyes and/or pigments dissolved or dispersed in mixtures of organic solvents having high boiling points and water.

There is a demand for an ink composition that is applicable to recording by the ink jet recording method on non-ink-absorbing or low-ink-absorbing recording media such as printing paper, synthetic paper, and films, as well as on water-absorbing recording media such as paper. Responding to such a demand, some ink compositions applicable to recording on non-ink-absorbing or low-ink-absorbing recording media have been proposed (see JP-A-2007-217671).

In addition, inks containing polysiloxane surfactants are known. For example, a W/0 type emulsion stencil ink containing two or more surfactants having different HLB values (see JP-A-6-220383) and a water-free planographic ink composition containing one or more nonionic surfactants having an HLB value in a range of 11 to 15 (see JP-A-63-178178) are known.

Unfortunately, since the ink composition proposed in JP-A-2007-217671 contains an organic solvent having a high boiling point, the ink tends to insufficiently dry in recording on a non-ink-absorbing or low-ink-absorbing recording medium, and deterioration in printing quality, such as uneven density defects, blocking, or ink adhesion defects, may be caused. In the ink composition not containing an organic solvent having a high boiling point, drying of nozzles of an ink jet recording head cannot be prevented to readily cause clogging of the nozzles, and also storage stability of some inks may be low.

The ink compositions proposed in JP-A-6-220383 and JP-A-63-178178 may cause, for example, repelling or uneven aggregation due to insufficient wettability on the surfaces of non-ink-absorbing recording media such as films and thereby give insufficient printing quality.

### SUMMARY

An advantage of some aspects of the invention is to provide an ink composition and an ink jet recording method that are applicable to printing on various recording media.

An advantage of some aspects of the invention is to provide an ink composition that can exhibit excellent printing quality, i.e., less repelling and uneven aggregation and excellent solid filling, on various recording media, in particular, non-ink-absorbing or low-ink-absorbing recording media, and also that can reduce clogging of nozzles, and has excellent storage stability. Another advantage of some aspects of the invention is to provide an ink jet recording method using the ink composition.

An advantage of some aspects of the invention is to solve at least a part of the disadvantages described above, and the invention can be realized as the following aspects or application examples.

### Application Example 1

An ink composition according to an aspect of the invention includes at least a coloring material, two or more polysiloxane surfactants having different solubilities in water, and alkyl polyols having a boiling point at one atmosphere of 180 to 230° C., wherein the ink composition does not substantially contain alkyl polyols having a boiling point at one atmosphere of 280° C. or more and enables recording on a non-ink-absorbing or low-ink-absorbing recording medium.

The ink composition according to Application Example 1 containing both the polysiloxane surfactants and the alkyl polyols can give high printing quality, such as less repelling and uneven aggregation and excellent solid filling, in printing on various recording media, in particular, non-ink-absorbing or low-ink-absorbing recording media, can reduce clogging of a nozzle, and has excellent storage stability.

### Application Example 2

The ink composition according to Application Example 1 may contain a lipophilic polysiloxane surfactant (a) having an HLB value of 4 to 8 or represented by the following Formula (1) having R being a methyl group and a hydrophilic polysiloxane surfactant (b) having an HLB value of 9 to 20 or represented by the following Formula (1) having R being a hydrogen atom:

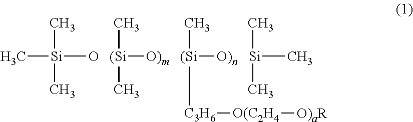

(wherein, R represents a hydrogen atom or a methyl group; a represents an integer of 2 to 13; m represents an integer of 0 or more; and n represents an integer of 1 to 5).

### Application Example 3

In the ink composition according to Application Example 2, the mass ratio of the lipophilic polysiloxane surfactant content to the hydrophilic polysiloxane surfactant content in the ink composition may be 1/20 or more and 2/1 or less.

### Application Example 4

In the ink composition according to Application Example 2 or 3, the content of the hydrophilic polysiloxane surfactant may be higher than that of the lipophilic polysiloxane surfactant in the ink composition.

### Application Example 5

The ink composition according to any one of Application Examples 1 to 4 may contain glycol ethers having an HLB value calculated by a Davies' method in a range of 4.2 to 8.0.

### Application Example 6

In the ink composition according to Application Example 5, the alkyl polyols can be C4-7 1,2-straight-chain alkyl diols, and the mass ratio of the C4-7 1,2-straight-chain alkyl diols to the glycol ethers can be higher than 1/1 and 20/1 or less.

### Application Example 7

An ink jet recording method according to an aspect of the invention can perform recording using an ink composition according to any one of Application Examples 1 to 6.

### Application Example 8

A recorded matter according to an aspect of the invention is of recorded by the ink jet recording method of Application Example 7.

### DESCRIPTION OF EXEMPLARY EMBODIMENT

A preferred embodiment of the invention will now be described in detail. The embodiment described below is merely an example of the invention. It is apparent that the invention is not limited to the following embodiment and includes various modifications made within the scope not changing the gist of the invention.

### 1. Ink Composition

An ink composition according to an aspect of the invention includes at least a coloring material, two or more polysiloxane surfactants having different solubilities in water, and alkyl polyols having a boiling point at one atmosphere of 180 to 230° C., wherein the ink composition does not substantially contain alkyl polyols having a boiling point at one atmosphere of 280° C. or more and enables recording on a non-ink-absorbing or low-ink-absorbing recording medium.

Each component used in the embodiment will now be described in detail.

### 2. Coloring Material

The ink composition according to the embodiment contains a coloring material. The coloring material is a dye or a pigment and is preferably a pigment from the viewpoint of having, for example, water resistance, gas resistance, and light resistance. The pigment may be an inorganic pigment or an organic pigment. These pigments may be used alone or as a mixture of two or more thereof. Examples of the inorganic pigment include carbon black produced by a known method such as a contact method, a furnace method, or a thermal method, in addition to titanium oxide and iron oxide. Examples of the organic pigment include azo pigments (including, for example, azolakes, insoluble azo pigments, condensed azo pigments, and chelate azo pigments), polycyclic pigments (for example, phthalocyanine pigments, perylene pigments, perynone pigments, anthraquinone pigments, quinacridone pigments, dioxadine pigments, thioindigo pigments, isoindolinone pigments, and quinophthalone pigments), dye chelates (for example, basic dye-type chelates and acid dye-type chelates), nitro pigments, nitroso pigments, and aniline black.

Examples of yellow organic pigments include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 150, 151, 153, 154, 155, 167, 172, 180, 185, 188, and 213.

Examples of magenta organic pigments include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 53, 57(Ca), 57:1, 88, 112, 114, 122, 123, 144, 146, 149, 150, 166, 168, 170, 171, 175, 176, 177, 178, 179, 184, 185, 187, 194, 202, 209, 219, 224, 245, 247, 254, and 264; and C.I. Pigment Violet 19, 23, 32, 33, 36, 38, 43, and 50.

Examples of cyan organic pigments include C.I. Pigment Blue 1, 2, 3, 15, 15:1, 1 5:2, 15:3, 15:4, 15:6, 15:34, 16, 18, 22, 25, 60, 65, 66, and 75; and C.I. Vat Blue 4 and 60.

Examples of black pigments include inorganic pigments such as carbon blacks (C.I. Pigment Black 7), e.g., furnace black, lamp black, acetylene black, and channel black, and iron oxide pigments; and organic pigments such as aniline black (C.I. Pigment Black 1).

Other examples of the pigment include C.I. Pigment Green 7, 10, 36, and 37; C.I. Pigment Brown 3, 5, 25, and 26; C.I. Pigment Orange 2, 5, 7, 13, 14, 15, 16, 24, 34, 36, 38, 40, 43, 63, and 64; and C.I. Pigment White 4, 6, 6:1, 7, 18, and 26.

The content of these pigments is preferably in the range of 0.5% by mass or more and 20% by mass or less, more preferably 1% by mass or more and 10% by mass or less, of the total amount of the ink composition. A content of less than 0.5% by mass may cause an insufficient printing density (color-developing property). A content of higher than 20% by mass may decrease reliability, such as deterioration of glossiness on glossy media, nozzle clogging, and unstable discharging.

The volume-average particle diameter (hereinafter, in some cases, referred to as average particle diameter) of the pigment in an ink is preferably in the range of 50 to 400 nm, from the viewpoints of color development and glossiness on glossy media. The average particle diameter can be determined by particle size measurement with, for example, Microtrac UPA150 (manufactured by Microtrac) or particle size distribution analyzer LPA3100 (manufactured by Otsuka Electronics).

### 3. Dispersant

In order to apply the pigment to an ink composition, the pigment is required to be stably dispersed in water. Examples of the method therefor include a method of dispersing a pigment with a resin dispersant such as a water-soluble resin and/or a water-dispersible resin (hereinafter, the pigment treated by this method is referred to as “resin-dispersed pigment”), a method of dispersing a pigment with a water-soluble surfactant and/or a water-dispersible surfactant (hereinafter, the pigment treated by this method is referred to as “surfactant-dispersed pigment”), and a method of chemically and physically introducing a hydrophilic functional group to the surface of a pigment particle so that the pigment can be dispersed and/or dissolved in water without dispersants such as the resin and the surfactant (hereinafter, the pigment treated by this method is referred to as “surface-treated pigment”). The ink composition according to the embodiment can contain any of the resin-dispersed pigment, the surfactant-dispersed pigment, and the surface-treated pigment. Though these pigments can be optionally used in combination, the resin-dispersed pigment is preferred.

Examples of the resin dispersant used in the resin-dispersed pigment include polyvinyl alcohols, polyacrylic acids, acrylic acid-acrylnitrile copolymers, vinyl acetate-acrylic acid ester copolymers, acrylic acid-acrylic acid ester copolymers, styrene-acrylic acid copolymers, styrene-methacrylic acid copolymers, styrene-methacrylic acid-acrylic acid ester copolymers, styrene-α-methylstyrene-acrylic acid copolymers, styrene-α-methylstyrene-acrylic acid-acrylic acid ester copolymers, styrene-maleic acid copolymers, styrene-maleic anhydride copolymers, vinylnaphthalene-acrylic acid copolymers, vinylnaphthalene-maleic acid copolymers, vinyl acetate-maleic acid ester copolymers, vinyl acetate-crotonic acid copolymers, and vinyl acetate-acrylic acid copolymers; and salts thereof. Among these resin dispersants, preferred are copolymers of monomers having hydrophobic functional groups and monomers having hydrophilic functional groups, and polymers of monomers having both hydrophobic functional groups and hydrophilic functional groups. The copolymers may be in any form of random copolymers, block copolymers, alternating copolymers, and graft copolymers.

Examples of the salt include salts with basic compounds, such as ammonia, ethylamine, diethylamine, triethylamine, propylamine, isopropylamine, dipropylamine, butylamine, isobutylamine, diethanolamine, triethanolamine, triisopropanolamine, aminomethyl propanol, and morpholine. These basic compounds may be added in an amount that is not lower than neutralization equivalent of the resin dispersant.

The molecular weight of the resin dispersant is preferably in the range of 1000 to 100000, more preferably 3000 to 10000, as a weight-average molecular weight. A resin dispersant having a molecular weight in this range can stably disperse the pigment in water and can easy control, for example, viscosity when it is applied to an ink composition.

The acid number of the resin dispersant is preferably in the range of 20 to 300, more preferably 40 to 150. A resin dispersant having an acid number in this range stabilizes the dispersibility of pigment particles in water and enhances the water resistance and the color-developing property of a recorded matter recorded with an ink composition containing the resin dispersant.

The resin dispersant mentioned above may be commercially available one, and specific examples thereof include Joncryl 67 (weight-average molecular weight: 12500, acid number: 213), Joncryl 678 (weight-average molecular weight: 8500, acid number: 215), Joncryl 586 (weight-average molecular weight: 4600, acid number: 108), Joncryl 611 (weight-average molecular weight: 8100, acid number: 53), Joncryl 680 (weight-average molecular weight: 4900, acid number: 215), Joncryl 682 (weight-average molecular weight: 1700, acid number: 238), Joncryl 683 (weight-average molecular weight: 8000, acid number: 160), and Joncryl 690 (weight-average molecular weight: 16500, acid number: 240) (these are trade names, manufactured by BASF Japan Corp.).

Examples of the surfactant used in the surfactant-dispersed pigment include anionic surfactants such as alkanesulfonates, α-olefin sulfonates, alkylbenzene sulfonates, alkylnaphthalene sulfonates, acylmethyl taurates, dialkyl sulfosuccinates, alkyl sulfates, sulfated olefins, polyoxyethylene alkyl ether sulfates, alkyl phosphates, polyoxyethylene alkyl ether phosphates, and monoglyceride phosphates; amphoteric surfactants such as alkylpyridium salts, alkyl amino acid salts, and alkyl dimethyl betaines; and nonionic surfactants such as polyoxyethylene alkyl ethers, polyoxyethylene alkyl phenyl ethers, polyoxyethylene alkyl esters, polyoxyethylene alkyl amides, glycerin alkyl esters, and sorbitane alkyl esters.

The amount of the resin dispersant or the surfactant is preferably 1 to 100 parts by mass, more preferably 5 to 50 parts by mass, based on 100 parts by mass of the pigment. In this range, dispersion stability of the pigment in water can be ensured.

Examples of the hydrophilic functional group of the surface-treated pigment include —OM, —COOM, —CO—, —SO₃M, —SO₂NH₂, —RSO₂M, —PO₃HM, —PO₃M₂, —SO₂NHCOR, —NH₃, and —NR₃ (in the formulae, M denotes a hydrogen atom, an alkali metal, ammonium, or organic ammonium; and R denotes an alkyl group having 1 to 12 carbon atoms, a phenyl group optionally having a substituent, or a naphthyl group optionally having a substituent). The functional group is physically and/or chemically introduced onto the surface of a pigment particle by direct grafting and/or via a multivalent group. Examples of the multivalent group include alkylene groups having 1 to 12 carbon atoms, phenylene groups optionally having substituents, and naphthylene groups optionally having substituents.

The above-mentioned surface-treated pigment is preferably pigment particles having surfaces treated with a sulfur-containing treatment agent so that —SO₃M and/or —RSO₂M (M represents a counter ion and denotes a hydrogen ion, an alkali metal ion, an ammonium ion, or an organic ammonium ion) chemically bonds to the pigment particle surfaces, i.e., pigment particles dispersed and/or dissolved in water by dispersing the pigment particles in a solvent that does not have an active proton, does not have reactivity with sulfonic acid, and does not dissolve or hardly dissolves the pigment and subsequently treating the surfaces of the resin particles with amidosulfuric acid or a complex of sulfur trioxide and tertiary amine so that —SO₃M and/or —RSO₂M chemically bonds to the particle surfaces.

One pigment particle may be grafted with one kind of functional group or a plurality of kinds of functional groups. The kind and the amount of the functional group to be grafted may be appropriately determined with consideration for, for example, dispersion stability in the ink, color density, and the drying property at the front face of an ink jet recording head.

The resin-dispersed pigment, the surfactant-dispersed pigment, and the surface-treated pigment described above can be each dispersed in water by mixing a pigment, water, and a resin dispersant for the resin-dispersed pigment; a pigment, water, and a surfactant for the surfactant-dispersed pigment; or a surface-treated pigment and water for the surface-treated pigment, optionally with a water-soluble organic solvent, a neutralizer, and other components, using a disperser that is commonly used, such as a ball mill, a sand mill, an attritor, a roll mill, an agitator mill, a Henschel mixer, a colloid mill, an ultrasonic homogenizer, a jet mill, or an angmill. In these cases, the dispersing is preferably performed until the pigment particles have an average particle diameter of 20 to 500 nm, more preferably 20 to 200 nm, and most preferably 50 to 180 nm, for ensuring dispersion stability of the pigment in water.

Throughout the specification, the term “average particle diameter” refers to the average particle diameter on volume-basis unless specifically noted otherwise. The average particle diameter can be measured with a particle size distribution analyzer of which measurement principle is a laser diffraction and scattering method. As the laser diffraction particle size distribution analyzer, for example, a particle size distribution analyzer of which measurement principle is a dynamic light scattering method (e.g., “Microtrac UPA series”, manufactured by Nikkiso Co., Ltd.) can be used.

### 4. Water-Insoluble Resin

In the invention, the resin dispersant may be a water-insoluble resin. The water-insoluble resin has a solubility of less than 1 g in 100 g of water at 25° C. The water-insoluble resin may have any structure. Preferred examples of the water-insoluble resin are the following two types.

The first preferred example of the water-insoluble resin is a block copolymer resin composed of a monomer having a hydrophobic group and a monomer having a hydrophilic group and including a monomer having at least a salt-forming group.

Examples of the monomer having a hydrophobic group include methacrylic acid esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl esters such as vinyl acetate; vinyl cyanide compounds such as acrylonitrile and methacrylonitrile; and aromatic vinyl monomers such as styrene, α-methylstyrene, vinyl toluene, 4-t-butylstyrene, chlorostyrene, vinylanisole, and vinylnaphthalene. These monomers can be used alone or as a mixture of two or more thereof.

Examples of the monomer having a hydrophilic group include polyethylene glycol monomethacrylate, polypropylene glycol monomethacrylate, and ethylene glycol/propylene glycol monomethacrylate. These monomers can be used alone or as a mixture of two or more thereof. In particular, the glossiness of printed images is enhanced by using a monomer component constituting a branched chain such as polyethylene glycol (2-30) monomethacrylate, polyethylene glycol (1-15)/propylene glycol (1-15) monomethacrylate, polypropylene glycol (2-30) methacrylate, methoxypolyethylene glycol (2-30) methacrylate, methoxypolytetramethylene glycol (2-30) methacrylate, or methoxy(ethylene glycol/propylene glycol copolymer) (1-30) methacrylate.

Examples of the monomer having a salt-forming group include acrylic acid, methacrylic acid, styrenecarboxylic acid, and maleic acid. These can be used alone or as a mixture of two or more thereof.

Furthermore, a macromonomer such as a styrene macromonomer having a polymerizable functional group at one end or a silicone monomer or another monomer may be used together.

The second preferred example of the water-insoluble resin is one having a hydrophilic structural unit (a) and a hydrophobic structural unit (b). The hydrophilic structural unit (a) may be any unit derived from a hydrophilic group-containing monomer and may be derived from a single hydrophilic group-containing monomer or from two or more hydrophilic group-containing monomers. The hydrophilic group is not particularly limited and may be a dissociative group or a nonionic hydrophilic group.

In the water-insoluble resin in the invention, a dissociative group or a nonionic hydrophilic group can be introduced using a monomer having a dissociative group (dissociative group-containing monomer) and/or a monomer having a nonionic hydrophilic group.

The dissociative group is preferred from the viewpoint of stabilizing an emulsion or dispersion state. Examples of the dissociative group include carboxyl, phosphate, and sulfonate groups. In particular, the carboxyl group is preferred from the viewpoint of dispersion stability of an ink composition.

The hydrophilic group-containing monomer is preferably a dissociative group-containing monomer, more preferably a dissociative group-containing monomer having a dissociative group and an ethylene unsaturated bond. Examples of the dissociative group-containing monomer include unsaturated carboxylic acid monomers, unsaturated sulfonic acid monomers, and unsaturated phosphoric acid monomers.

The hydrophobic structural unit (b) preferably has a structural unit having an aromatic ring linked to an atom forming the main chain via a linker group. In such a structural unit having an aromatic ring, the aromatic ring is linked to an atom constituting the main chain of a water-insoluble resin via a linker group and is not directly linked to an atom constituting the main chain of the water-insoluble resin to maintain an appropriate distance between the hydrophobic aromatic ring and the hydrophilic structural unit. As a result, interaction between the water-insoluble resin and the pigment readily occurs to cause strong adsorption to further enhance dispersibility.

The water-insoluble resin as the second example is described in more detail in JP-A-2011-162692.

Preferred examples of the water-insoluble resin are styrene-(meth)acrylic copolymers as in the above-described water-soluble resin.

The molecular weight of the resin dispersant is preferably in the range of 1000 to 100000, more preferably 3000 to 10000, as a weight-average molecular weight. A resin dispersant having a molecular weight in this range can stably disperse the pigment in water and can easy control, for example, viscosity when it is applied to an ink composition.

The acid value of the resin dispersant is preferably in the range of 50 to 300, more preferably 70 to 150. A resin dispersant having an acid number in this range stabilizes the dispersibility of pigment particles in water and enhances the water resistance of a recorded matter recorded with an ink composition containing the resin dispersant.

### 5. Alkyl Polyols

The ink composition according to the embodiment contains alkyl polyols having a boiling point at one atmosphere of 180 to 230° C. The ink composition according to the embodiment can control the wettability, permeability, and drying property of the ink composition irrespective of the type of a recording medium by containing the alkyl polyols having a boiling point satisfying the above-mentioned range. Consequently, recorded images exhibit excellent fixability to various recording media, in particular, to non-ink-absorbing and low-ink-absorbing recording media, and also clogging of nozzles of an ink jet recording head is decreased.

The alkyl polyols contained in the ink composition according to the embodiment also have characteristics of solubilizing glycol ethers having an HLB value calculated by the Davies' method in the range of 4.2 to 8.0 and lipophilic polysiloxane in an ink vehicle.

The alkyl polyols contained in the ink composition according to the embodiment have a boiling point at one atmosphere in the range of 180 to 230° C. and preferably include at least one type of a polyol having a boiling point in the range of 190 to 220° C. The alkyl polyols are preferably C4-7 1,2-straight-chain alkyl diols. The ratio of (the mass of C4-7 1,2-straight-chain alkyl diols)/(the mass of the glycol ethers) is preferably higher than 1/1 and 20/1 or less from the viewpoint of compatibility with the glycol ethers. The mass ratio is more preferably 2/1 or more and 16/1 or less, most preferably 4/1 or more and 16/1 or less.

If the a boiling point at one atmosphere of alkyl polyols contained in the ink composition is less than 180° C., the drying property of the ink composition may be increased to cause clogging of the nozzles of an ink jet recording head. A boiling point at one atmosphere of higher than 230° C. may decrease the drying property of the ink composition to cause considerable uneven density defects in an image recorded on, in particular, a non-ink-absorbing recording medium and to cause a decrease in fixability of the image.

Specific examples of the alkyl polyols having a boiling point at one atmosphere in the range of 180 to 230° C. include propylene glycol [188° C.], 1,3-propanediol [210° C.], 1,2-butanediol [194° C.], 1,3-butanediol [208° C.], 1,4-butanediol [230° C.], 1,2-pentanediol [210° C.], 3-methyl-1,3-butanediol [203° C.], 2-ethyl-2-methyl-1,3-propanediol [226° C.], 2-methyl-1,3-propanediol [214° C.], 2-methyl-2-propyl-1,3-propanediol [230° C.], 2,2-dimethyl-1,3-propanediol [210° C.], 2-methylpentane-2,4-diol [197° C.], dipropylene glycol [230° C.], and 1,2-heptanediol [227° C.]. The numerical values in parentheses show boiling points at one atmosphere.

The content of the alkyl polyols is preferably in the range of 5% by mass or more and 30% by mass or less of the total amount of the ink composition from the viewpoints of effects of increasing wettability and permeability to a recording medium to reduce uneven density defects and ensuring high ink storage stability and discharging reliability. A content of less than 5% by mass may decrease the storage stability of the ink composition and increase the drying property of the ink composition to cause clogging of nozzles of an ink jet recording head. In contrast, a content of higher than 30% by mass may decrease the drying property of the ink composition to cause considerable uneven density defects in an image recorded on a non-ink-absorbing recording medium and may decrease fixability of the image. In addition, it is difficult to regulate the viscosity of the ink composition to a range suitable for an ink jet recording system.

Among the above-mentioned alkyl polyols, in particular, 1,2-straight chain alkyl diols having 4 to 7 carbon atoms (hereinafter also abbreviated to “C4-7”) synergize with the glycol ethers and the lipophilic polysiloxane, which are essential components of the invention, to show an effect of further increasing wettability of the ink composition to uniformly wet a recording medium and an effect of further increasing permeability, in addition to the above-mentioned effects. Accordingly, uneven density defects of ink can be further decreased by adding C4-7 1,2-straight chain alkyl diols to the ink composition. In addition, the C4-7 1,2-straight chain alkyl diols exhibit high compatibility with the above-described glycol ethers and the lipophilic polysiloxane. Throughout the specification, the term “compatibility” refers to a combination of materials and a ratio of the materials among the components constituting an ink composition such that a mixture of the glycol ethers, the lipophilic polysiloxane, and the C4-7 1,2-straight chain alkyl diols is completely dissolved in an ink composition of which main solvent is water. The solubility of the glycol ethers and the lipophilic polysiloxane in an ink composition can be increased by adding C4-7 1,2-straight chain alkyl diols having high compatibility with the glycol ethers and the lipophilic polysiloxane to the ink composition, and thereby the ink storage stability and discharge stability can be enhanced. In addition, since the contents of the glycol ethers and the lipophilic polysiloxane in an ink composition can be easily increased, the quality of a recorded image can be further improved.

Specific examples of the C4-7 1,2-straight chain alkyl diols having such characteristics include 1,2-butanediol [194° C.], 1,2-pentanediol [210° C.], 1,2-hexanediol [224° C.], and 1,2-heptanediol [227° C.]. Among them, in particular, C4-6 1,2-straight chain alkyl diols (1,2-straight chain alkyl diols having 4 to 6 carbon atoms), such as 1,2-butanediol, 1,2-pentanediol, and 1,2-hexanediol, are preferred from the viewpoints of solubility in water, compatibility with the glycol ethers, moisture-retaining property against nozzle clogging, and also drying property of a printed image. For example, the amount of the C4-6 1,2-straight chain alkyl diols is preferably 50% by mass or more of the amount of the alkyl polyols in an ink.

The content of the C4-7 1,2-straight chain alkyl diols is preferably in the range of 0.5 to 25% by mass, most preferably 1 to 20% by mass, of the total amount of the ink composition from the viewpoints of compatibility with the glycol ethers and lipophilic polysiloxane, storage stability of the ink composition, and ensuring discharge stability, in particular, preventing clogging. In particular, in the second step (drying step) of an ink jet recording method using the ink composition, which is described below, since the evaporation and scattering rate of the C4-7 1,2-straight chain alkyl diols are sufficiently high, the drying rate of a recorded matter increases, resulting in a specific effect of accelerating the recording rate. In addition, no problem of odor occurs in each step.

The ink composition of the invention does not substantially contain alkyl polyols having a boiling point at one atmosphere of 280° C. or more. If an ink composition contains alkyl polyols having a boiling point at one atmosphere of 280° C. or more, the drying property of the ink composition is considerably decreased not only to cause considerable uneven density defects in an image recorded on various recording media, in particular, on a non-ink-absorbing or low-ink-absorbing recording medium but also to cause a decrease in fixability of the image. Examples of the alkyl polyols having a boiling point at one atmosphere of 280° C. or more include glycerin having a boiling point at one atmosphere of 290° C.

In the invention, the term “not substantially containing” refers to that a material is not contained in an amount for sufficiently exhibiting a consequence of the addition. Specific examples of “not substantially containing” alkyl polyols include containing the alkyl polyols in an amount of less than 1.0% by mass, preferably less than 0.5% by mass, more preferably less than 0.1% by mass, further preferably less than 0.05% by mass, particularly preferably less than 0.01% by mass, and most preferably less than 0.001% by mass.

### 6. Polysiloxane Surfactant

An aqueous pigment ink composition of the invention contains two or more polysiloxane surfactants having different HLB values. The HLB value of a polysiloxane surfactant is a value of 0 to 20 determined by a Griffin method.

In a preferred aspect of the invention, the ink composition contains one or more lipophilic polysiloxane surfactants having an HLB value of 2 to 8 and one or more hydrophilic polysiloxane surfactants having an HLB value of 9 to 20. A surfactant having an HLB value of less than 4 has low solubility in an aqueous ink solvent and is therefore not preferred. The HLB value of a surfactant used as the hydrophilic polysiloxane surfactant is preferably 9 to 20, more preferably 9 to 16.

The “HLB value (hydrophilic lipophilic balance)” is a value determined from the balance between the hydrophilic group and the lipophilic group of a surfactant molecule. A higher HLB value indicates that the surfactant has higher hydrophilicity, while a lower HLB value indicates that the surfactant has higher lipophilicity. Throughout the specification, the terms “hydrophilic” and “lipophilic” merely mean that in relative comparison of two polysiloxane surfactants having different HLB values, one polysiloxane surfactant having a higher HLB value is “hydrophilic”, and the other is “lipophilic”; and the terms the “hydrophilic” polysiloxane surfactant and the “lipophilic” polysiloxane surfactant do not respectively mean a hydrophilic surfactant and a lipophilic surfactant in general definition. The polysiloxane surfactant is preferably a polyether siloxane surfactant.

The polysiloxane surfactant may be a commercially available one. Examples of the hydrophilic polysiloxane surfactant include KF-6011 (HLB value=14.5), KF-6013 (HLB value=10), KF-6004 (HLB value=9), KF-6043 (HLB value=14.5), KF-643 (HLB value=14), KF-640 (HLB value=14), KF-351A (HLB value=12), and KF-354L (HLB value=16) (these are manufactured by Shin-Etsu Chemicals Co., Ltd.); and FZ-2105 (HLB value=11), L-7604 (HLB value=13), and FZ-2104 (HLB value=14) (these are manufactured by Dow-Toray Corning Co., Ltd.). Examples of the lipophilic polysiloxane surfactant include KF-945 (HLB value=4), KF-6020 (HLB value=4), X-22-6191 (HLB value=2), X-22-4515 (HLB value=5), KF-6015 (HLB value=5), KF-6017 (HLB value=5), and KF-6038 (HLB value=3) (these are manufactured by Shin-Etsu Chemicals Co., Ltd.); and FZ-2116 (HLB value=5), FZ-2120 (HLB value=6), L-720 (HLB value=7), L-7002 (HLB value=7), and FZ-2123 (HLB value=8) (these are manufactured by Dow-Toray Corning Co., Ltd.).

The content of the polysiloxane surfactant in the aqueous pigment ink composition of the invention is not particularly limited. The total mass of the hydrophilic polysiloxane surfactant and the lipophilic polysiloxane surfactant is preferably 0.01 to 10% by mass, more preferably 0.05 to 2% by mass, of the total mass of the aqueous pigment ink composition. In a content of less than 0.01% by mass, the effect of reducing the surface tension may be insufficient. In a content of higher than 10% by mass, the hydrophilic polysiloxane surfactant and the lipophilic polysiloxane surfactant are not dissolved to deteriorate wettability on nozzle faces.

The ratio of the lipophilic polysiloxane surfactant content to the hydrophilic polysiloxane surfactant content in the aqueous pigment ink composition of the invention is not particularly limited. The mass ratio of the lipophilic polysiloxane surfactant content to the hydrophilic polysiloxane surfactant content is preferably 1/20 to 2/1, more preferably 1/15 to 1/3. If the mass ratio is less than 1/20 or higher than 2/1, the effects of the invention, i.e., the effects of providing good glossiness and enhancing distinctness of an image may be decreased. In addition, as mentioned above, the amount of the hydrophilic polysiloxane surfactant is preferably higher than that of the lipophilic polysiloxane surfactant, and more preferably the amount of the hydrophilic polysiloxane surfactant is 2 or more times that of the lipophilic polysiloxane surfactant.

Furthermore, polysiloxane surfactants represented by the following Formula (1) are preferred. The polysiloxane surfactants are not particularly limited, but it is preferable that when an aqueous solution is composed of 20% by mass of propylene glycol, 10% by mass of 1,2-hexanediol, 0.1% by mass of the polyether siloxane surfactant, and 69.9% by mass of water, the dynamic surface tension of the aqueous solution is 26 mN/m or less at 1 Hz. The dynamic surface tension can be measured using, for example, a bubble pressure dynamic surface tensiometer BP2 (manufactured by Kruss GmbH).

The polysiloxane surfactants preferably include one or more compounds represented by the following Formula (1):

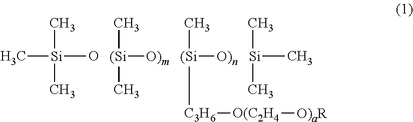

(wherein, R represents a hydrogen atom or a methyl group; a represents an integer of 2 to 13; m represents an integer of 0 or more; and n represents an integer of 1 to 5). More preferably, the polysiloxane surfactants include one or more compounds represented by Formula (1) wherein R represents a hydrogen atom or a methyl group; a represents an integer of 2 to 11; m represents an integer of 20 to 70; and n represents an integer of 2 to 5. Furthermore, the polysiloxane surfactants more preferably include one or more compounds represented by Formula (1) wherein R represents a hydrogen atom or a methyl group; a represents an integer of 9 to 13; m represents an integer of 2 to 4; and n represents an integer of 1 or 2.

The use of such specific polysiloxane surfactants can further prevent bleeding and beading of an ink even in printing on a non-ink-absorbing medium or printing paper.

The use of a lipophilic polysiloxane surfactant represented by Formula (1) having R being a methyl group can further prevent beading of an ink. Furthermore, the use of both a lipophilic polysiloxane surfactant represented by Formula (1) having R being a methyl group and a hydrophilic polysiloxane surfactant represented by Formula (1) having R being a hydrogen atom can further prevent bleeding of an ink. The content of the surfactant represented by Formula (1) having R being a methyl group is preferably 0.01 to 1.0% by mass, more preferably 0.05 to 0.70% by mass.

Furthermore, a high-quality image free from bleeding and beading can be formed by appropriately regulating the blending ratio between the compound represented by Formula (1) having R being a methyl group and the compound represented by Formula (1) having R being a hydrogen atom. In addition, the fluidity varying depending on the type of the pigment and the amount of the resin can be effectively adjusted by regulating the blending ratio.

The surfactant mentioned above may be a commercially available one. Examples of the surfactant include Olfine PD-501 and Olfine PD-570 (manufactured by Nissin Chemical Industry Co., Ltd.); KF-954A, KF-353A, KF6017, X-22-6551, and AW-3 (these are manufactured by Shin-Etsu Chemicals Co., Ltd.); and BYK-347 and BYK-348 (these are manufactured by BYK-Chemie Japan, Inc.).

The ink composition according to the invention may further contain another surfactant, specifically, for example, a fluorine surfactant, an acetylene glycol surfactant, an anionic surfactant, a nonionic surfactant, or an amphoteric surfactant.

Among these surfactants, the acetylene glycol surfactant is preferred. In such a case, an ink is prevented from foaming and has a reduced surface tension.

Examples of the acetylene glycol surfactant include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, GA, and DF110D (these are trade names, manufactured by Air Products and Chemicals, Inc.); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (these are trade names, manufactured by Nissin Chemical Industry Co., Ltd.); and Acetyrenol E00, E00P, E40, and E100 (these are trade names, manufactured by Kawaken Fine Chemicals Co., Ltd.).

### 7. Glycol Ethers

The ink composition according to the embodiment preferably contains glycol ethers having an HLB value calculated by a Davies' method in the range of 4.2 to 8.0. In the ink composition according to the embodiment containing the glycol ethers having an HLB value in the above-mentioned range, the wettability and the permeation rate can be controlled with less influence by difference of recording media. Consequently, clear images with less uneven density defects can be recorded on various recording media, in particular, non-ink-absorbing and low-ink-absorbing recording media.

The HLB value of the glycol ethers used in the embodiment is a value proposed by Davies, et al. for evaluating hydrophilicity of a compound and is determined by a Davies' method that is defined in, for example, J. T. Davies and E. K. Rideal, “Interface Phenomena”, 2nd ed., Academic Press, New York, 1963. The HLB value can be calculated by the following Expression (2):

HLB value=7+Σ[1]+Σ[2] (2)

(wherein [1] represents the number of hydrophilic groups, and [2] represents the number of hydrophobic groups).

Table 1 shows typical hydrophilic groups and hydrophobic groups and the numbers thereof.

TABLE 1

| | Number of |
|---|---|
| Structure | groups |
| —CH₂— | −0.475 |
| —CH₃ | −0.475 |
| —(CH₂CH₂O)— | +0.330 |
| 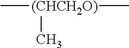 | −0.150 |
| —OH | +1.900 |

The glycol ethers contained in the ink composition according to the embodiment have an HLB value calculated by the Davies' method in the range of 4.2 to 8.0, more preferably 5.8 to 8.0. Glycol ethers having an HLB value of less than 4.2 has high hydrophobicity and low affinity to water serving as a main solvent. Such glycol ethers may decrease storage stability of the ink. Glycol ethers having an HLB value of higher than 8.0 decreases the wettability and permeability of an ink to a recording medium. Such glycol ethers may cause considerable uneven density defects in an image. In particular, the wettability to a hydrophobic surface, i.e., a non-ink-absorbing or low-ink-absorbing recording medium tends to significantly decrease.

Specific examples of the glycol ethers include ethylene glycol monoisobutyl ether, ethylene glycol monohexyl ether, ethylene glycol monoisohexyl ether, diethylene glycol monohexyl ether, triethylene glycol monohexyl ether, diethylene glycol monoisohexyl ether, triethylene glycol monoisohexyl ether, ethylene glycol monoisoheptyl ether, diethylene glycol monoisoheptyl ether, triethylene glycol monoisoheptyl ether, ethylene glycol monooctyl ether, ethylene glycol monoisooctyl ether, diethylene glycol monoisooctyl ether, triethylene glycol monoisooctyl ether, ethylene glycol mono-2-ethylhexyl ether, diethylene glycol mono-2-ethylhexyl ether, triethylene glycol mono-2-ethylhexyl ether, diethylene glycol mono-2-ethylpentyl ether, ethylene glycol mono-2-ethylpentyl ether, ethylene glycol mono-2-methylpentyl ether, diethylene glycol mono-2-methylpentyl ether, propylene glycol monobutyl ether, dipropylene glycol monobutyl ether, tripropylene glycol monobutyl ether, propylene glycol monopropyl ether, dipropylene glycol monopropyl ether, and tripropylene glycol monomethyl ether. These glycol ethers can be used alone or as a mixture of two or more thereof.

Among these glycol ethers, glycol ethers of which alkyl groups have branched structures are more preferred. The ink composition containing glycol ethers of which alkyl groups have branched structures can form clear images having less uneven density defects on, in particular, non-ink-absorbing and low-ink-absorbing recording media. Specific examples of such glycol ethers include ethylene glycol monoisobutyl ether, ethylene glycol monoisohexyl ether, diethylene glycol monoisohexyl ether, triethylene glycol monoisohexyl ether, ethylene glycol monoisoheptyl ether, diethylene glycol monoisoheptyl ether, triethylene glycol monoisoheptyl ether, ethylene glycol monoisooctyl ether, diethylene glycol monoisooctyl ether, triethylene glycol monoisooctyl ether, ethylene glycol mono-2-ethylhexyl ether, diethylene glycol mono-2-ethylhexyl ether, triethylene glycol mono-2-ethylhexyl ether, diethylene glycol mono-2-ethylpentyl ether, ethylene glycol mono-2-ethylpentyl ether, ethylene glycol mono-2-methylpentyl ether, and diethylene glycol mono-2-methylpentyl ether.

From the viewpoint of further increasing the color-developing property, the branched structure of the alkyl group of the glycol ethers is more preferably a 2-methylpentyl group, a 2-ethylpentyl group, or a 2-ethylhexyl group, and most preferably a 2-ethylhexyl group. Specific examples of such glycol ethers include ethylene glycol mono-2-ethylhexyl ether, diethylene glycol mono-2-ethylhexyl ether, triethylene glycol mono-2-ethylhexyl ether, diethylene glycol mono-2-ethylpentyl ether, ethylene glycol mono-2-ethylpentyl ether, ethylene glycol mono-2-methylpentyl ether, and diethylene glycol mono-2-methylpentyl ether. Particularly preferred are ethylene glycol mono-2-ethylhexyl ether, diethylene glycol mono-2-ethylhexyl ether, and triethylene glycol mono-2-ethylhexyl ether.

The content of the glycol ethers is preferably in the range of 0.05% by mass or more and 6% by mass or less of the total amount of the ink composition from the viewpoints of increasing the wettability and permeability to a recording medium to reduce uneven density defects and ensuring excellent ink storage stability and discharging reliability. A content of less than 0.05% by mass decreases the wettability, permeability, and drying property of the ink composition, which may provide an unclear image or an insufficient printing density (color-developing property). In contrast, a content of higher than 6% by mass may increase the viscosity of ink to cause head clogging or may lead to incomplete dissolution in the ink composition to deteriorate the storage stability. The content of the glycol ethers is more preferably in the range of 0.1% by mass or more and 2% by mass or less of the total amount of the ink composition.

### 8. Resin Particles

The ink composition according to the embodiment contains polymer particles as resin particles. The ink composition containing the resin particles can form an image having excellent abrasive resistance on a recording medium. In particular, in the case of recording an image on a non-ink-absorbing or low-ink-absorbing recording medium such as a vinyl chloride, polypropylene, or polyethylene film with the ink composition containing the resin particles, the image can have excellent abrasion resistance through the second step (drying step) in an ink jet recording method described below. This is because that the resin particles have an effect of solidifying the ink and firmly fixing the solidified ink on the recording medium and that heating in the second step (drying step) in the ink jet recording method described below can further accelerate this effect of the resin particles.

The ink composition according to the embodiment contains first polymer particles. The resin constituting the first polymer particles is preferably selected from the group consisting of polyolefin resins, acrylic resins, methacrylic resins, styrene resins, urethane resins, acrylamide resins, epoxy resins, and mixtures of these resins. In particular, the resin is preferably selected from the group consisting of polyolefin resins, acrylic resins, and urethane resins. The polyolefin resins are preferably selected from ethylene-polar monomer copolymers and olefin elastomers. These resins may be used as a homopolymer or a copolymer and may be used as a single-phase structure or a multi-phase structure (core-shell structure). More specific examples of the resin include ethylene-(meth)acrylic acid ester copolymers such as ethylene-(meth)acrylic acid ethyl ester copolymers, ethylene-(meth)acrylic acid methyl ester copolymers, ethylene-(meth)acrylic acid propyl ester copolymers, ethylene-(meth)acrylic acid butyl ester copolymers, ethylene-(meth)acrylic acid hexyl ester copolymers, ethylene-(meth)acrylic acid 2-hydroxyethyl ester copolymers, ethylene-(meth)acrylic acid 2-hydroxypropyl ester copolymers, and ethylene-(meth)acrylic acid glycidyl ester copolymers; ethylene-ethylene unsaturated acid copolymers such as ethylene-(meth)acrylic acid copolymers, ethylene-maleic acid copolymers, ethylene-fumaric acid copolymers, and ethylene-crotonic acid copolymers; ethylene-vinyl ester copolymers such as ethylene-vinyl acetate copolymers, ethylene-vinyl propionate copolymers, and ethylene-vinyl stearate copolymers; polyacrylic acid esters and copolymers thereof; polymethacrylic acid esters and copolymers thereof; polyacrylonitriles and copolymers thereof; polycyanoacrylates, polyacrylamides, polyacrylic acids, polymethacrylic acids, polyethylenes, polypropylenes, polybutenes, polyisobutylenes, and polystyrenes, and copolymers thereof; petroleum resins; coumarone-endene resins; terpene resins; polyvinyl acetates and copolymers thereof; polyvinyl alcohols, polyvinyl acetals, polyvinyl ethers, and polyvinyl chlorides, and copolymers thereof; polyvinylidene chlorides, fluororesins, fluororubbers, polyvinyl carbazoles, polyvinylpyridines, polyvinylimidazoles, and polybutadienes, and copolymers thereof; polychloroprenes; polyisoprenes; and natural resins. In particular, preferred are resins having high compatibility with non-ink-absorbing films, such as vinyl chloride, polypropylene, and polyethylene films, (i.e., having hydrophobic moieties in molecular structures), and also having hydrophilic moieties showing high adhesiveness. For example, ethylene-vinyl ester copolymers and ethylene-(meth)acrylic acid ester copolymers are preferred, and ethylene-vinyl acetate copolymers are more preferred.

In particular, emulsified ethylene-vinyl acetate polymer particles prepared by mixing about 8 to 35% by mass of a vinyl acetate monomer with an ethylene monomer and subjecting the mixture to emulsion polymerization under high pressure have excellent water resistance, weather resistance, and alkali resistance and have enhanced adhesiveness to films of polyolefins such as polypropylene and polyethylene and high abrasion resistance. Such an ethylene-vinyl acetate copolymer preferably contains 8 to 35% by mass, in particular, 12 to 30% by mass of vinyl acetate from the viewpoints of, for example, adhesiveness, abrasion resistance, and water resistance.

The first polymer particles preferably have an average particle diameter of 200 nm or more, more preferably 200 to 550 nm, and most preferably 200 to 350 nm. Polymer particles having an average particle diameter of less than 200 nm cannot impart sufficient abrasion resistance to a recorded matter formed on an ink-absorbing recording medium such as high-quality paper.

The first polymer particles preferably have a heat distortion temperature (in the specification, Tg or MFT) of less than 100° C., more preferably in the range of 0 to 90° C., more preferably in the range of 0 to 50° C., and most preferably in the range of 20 to 40° C. The first polymer particles preferably contain at least one type of such polymer particles. If the polymer particles have a heat distortion temperature of 100° C. or more, a heating temperature of 100° C. or more may be necessary in the second step (drying step) described below. In such a case, disadvantageously, the recording medium may contract or expand by the heat to cause wrinkles in a printed image. A component having a heat distortion temperature of 0° C. or more exhibits an effect of forming a strong resin coating in the second step (drying step) described below. As a result, the recorded image can have further improved abrasion resistance. In addition, clogging of an ink at the nozzle end of an ink jet recording head can be prevented. In contrast, in the case of using polymer particles composed of only components having a heat distortion temperature of less than 0° C., a strong resin coating may be hardly formed in the second step (drying step) described below to cause insufficient abrasion resistance of a recorded image. Furthermore, clogging tends to occur due to occurrence of solidified ink at the nozzle end.

The ink composition contains second polymer particles, and examples of the component constituting the second polymer particles include plant/animal waxes such as carnauba waxes, candelilla waxes, beeswax, rice waxes, and lanolin; petroleum waxes such as paraffin waxes, microcrystalline waxes, polyethylene waxes, oxidized polyethylene waxes, and petrolatum; mineral waxes such as montan waxes and ozokerite; synthetic waxes such as carbon waxes, Hoechst waxes, polyolefin waxes, and stearic acid amide; natural/synthetic wax emulsions such as α-olefin/maleic anhydride copolymers; and wax mixtures. These can be used alone or as a mixture. Among these waxes, preferred are polyolefin waxes, in particular, polyethylene waxes and polypropylene waxes. Polyethylene waxes are most preferred. Commercially available wax particles may be directly used, and examples thereof include Nopcoat PEM17 (trade name, manufactured by SAN NOPCO Limited), Chemipearl W4005 (trade name, manufactured by Mitsui Chemicals, Inc.), and AQUACER 507, AQUACER 515, AQUACER 526, AQUACER 531, AQUACER 537, AQUACER 552, AQUACER 593, AQUACER 840, and AQUACER 1547 (these are trade names, manufactured by BYK-Chemie Japan, Inc.).

The second polymer particles preferably have an average particle diameter of less than 200 nm, more preferably in the range of 20 to 100 nm. An average particle diameter of 200 nm or more decreases the abrasion resistance of recorded images formed on non-ink-absorbing recording media having smooth surfaces, such as films.

The heat distortion temperature of the second polymer particles is preferably 100° C. or more and is more preferably in the range of 100 to 200° C. from the viewpoint of abrasion resistance. If the heat distortion temperature is less than 100° C., the polymer particles soften due to frictional heat by rubbing, which leads to insufficient abrasion resistance.

In particular, when the ink composition according to the embodiment contains ethylene-vinyl acetate copolymer particles as the first polymer particles having an average particle diameter of 200 nm or more and a heat distortion temperature of less than 100° C. and polyethylene wax particles as the second polymer particles having an average particle diameter of less than 200 nm and a heat distortion temperature of 100° C. or more, printed images can have high abrasion resistance in every recording on ink-absorbing, low-ink-absorbing, and non-ink-absorbing recording media. The reason why the abrasion resistance of recorded images is increased by using these polymer particles described above has not been revealed yet, but it is assumed as follows.

The ethylene-vinyl acetate copolymer particles are constituted of a component showing good affinity to non-ink-absorbing and low-ink-absorbing recording media and a water-insoluble coloring material and are firmly fixed onto a recording medium while enwrapping a coloring material during forming a resin coating in the second step (drying step). In addition, the component constituting the polyethylene wax particles is also present on the surface of the resin coating and shows characteristics of decreasing the frictional resistance of the resin coating surface. Consequently, due to the synergy effect of the ethylene skeletons possessed by these resins, the formed resin coating is hardly abraded with friction from the outside and hardly detaches from the recording medium, and, therefore, the abrasion resistance of the recorded image increases.

The total amount of the first polymer particles having an average particle diameter of 200 nm or more and a heat distortion temperature of less than 100° C. and the second polymer particles having an average particle diameter of less than 200 nm and a heat distortion temperature of 100° C. or more is preferably in the range of 0.5 to 10% by mass of the total amount of the ink composition, in terms of solid content. In this range, the ink composition according to the embodiment can be solidified and fixed onto various recording media, in particular, even on non-ink-absorbing and low-ink-absorbing recording media, by combining with the second step (drying step) described below as a preferred ink jet recording method.

The content ratio of the first polymer particles to the second polymer particles (first polymer particles:second polymer particles) in the resin particles is preferably in the range of 1:5 to 10:1, expressed by mass in terms of solid content. Within this range, the above-described mechanism well works to increase the abrasion resistance of recorded images.

The first polymer particles and the second polymer particles contained in the ink composition according to the embodiment are preferably in a fine particle form (i.e., an emulsion or suspension form). The ink composition containing the resin particles in a fine particle form can easily control its viscosity to an appropriate range for an ink jet recording system and can easily ensure high storage stability and discharge stability.

### 9. Water

The ink composition according to the embodiment contains water. The water is a main solvent of the ink composition and is a component that evaporates and scatters in the second step (drying step) described below. The water is preferably water from which ionic impurities are removed as much as possible, such as pure water or ultrapure water, e.g., deionized water, ultrafiltration water, reverse osmosis water, or distilled water. Use of water that has been sterilized by, for example, UV irradiation or addition of hydrogen peroxide can prevent occurrence of molds or bacteria and is therefore preferred when a pigment dispersion or an ink composition containing the same is stored for a long time.

### 10. Other Additives

The ink composition according to the embodiment can further optionally contain, for example, a permeation solvent, a humectant, an antiseptic/antifungal agent, an antioxidant, a pH adjuster, or a chelating agent, in addition to the above-described constitutional components, from the viewpoint of improving the characteristics of the ink composition.

Examples of the antiseptic/antifungal agent include sodium benzoate, sodium pentachlorophenol, sodium 2-pyridinethiol-1-oxide, sodium sorbate, sodium dehydroacetate, and 1,2-dibenzine thiazolin-3-one (Proxel CRL, Proxel BND, Proxel GXL, Proxel XL-2, and Proxel TN, available from ICI Co., Ltd.).

Furthermore, examples of the pH adjuster or the antioxidant include amines such as diethanolamine, triethanolamine, propanolamine, and morpholine and modified products thereof; inorganic salts such as potassium hydroxide, sodium hydroxide, and lithium hydroxide; ammonium hydroxide; quaternary ammonium hydroxide (for example, tetramethyl ammonium); carbonates such as potassium carbonate, sodium carbonate, and lithium carbonate; phosphates; N-methyl-2-pyrrolidone; allophanates such as allophanate and methyl allophanate; biurets such as biuret, dimethyl biuret, and tetramethyl biuret; and L-ascorbic acid and salts thereof.

In addition, the ink composition according to the invention may contain an antioxidant and an ultraviolet absorber, and examples thereof include Tinuvin 328, 900, 1130, 384, 292, 123, 144, 622, 770, and 292, Irgacor 252 and 153, and Irganox 1010, 1076, 1035, and MD 1024 (available from Chiba Specialty Chemicals Inc.) and oxides of lanthanide.

### 11. Solubilization Aid

The ink composition according to the invention preferably contain a solubilization aid, in addition to the above-mentioned components.

The ink composition containing the solubilization aid shows characteristics that droplets of the ink composition uniformly spread, wet, and adhere to a recording medium, in particular, a non-ink-absorbing recording film such as a polyvinyl chloride, polyethylene terephthalate, polyethylene, or polypropylene film to form sharp and clear images with less uneven density defects and bleeding, even if the images are solid images.

Preferred examples of the solubilization aid include pyrrolidones such as N-methyl-2-pyrrolidone and 2-pyrrolidone; lactones such as γ-butyrolactone; sulfoxides such as dimethyl sulfoxide; imidazolidinones such as 1,3-dimethyl-2-imidazolidinone; and ureas such as urea, thiourea, and tetramethylurea. In particular, pyrrolidones and lactones are preferred. The amount of the solubilization aid may be appropriately determined, and is preferably about 0.1 to 30% by mass, more preferably about 0.1 to 10% by mass, more preferably about 0.5 to 5% by mass, and most preferably 1 to 3% by mass. For example, 2-pyrrolidone has a relatively high boiling point (245° C.), and an ink containing a large amount of 2-pyrrolidone may hardly dry to decrease the abrasion resistance of an image printed on a non-ink-absorbing medium.

### 12. Physical Properties of Ink Composition

The pH of the ink composition is preferably neutral or alkaline and more preferably in the range of 7.0 to 10.0. If the pH is acidic, the storage stability and the dispersion stability of the ink composition may be deteriorated, and defects such as corrosion of metal parts used in the ink channel of an ink jet recording apparatus tend to occur. The pH can be adjusted to neutral or alkali with the above-mentioned pH adjuster.

The ink composition preferably has a viscosity at 20° C. in the range of 1.5 to 15 mPa·s. In this range, the ink can ensure high discharge stability in the first step described below.

The ink composition preferably has a surface tension at 25° C. of 15 to 40 mN/m, more preferably 20 to 30 mN/m. In this range, the ink can ensure high discharge stability in the first step described below and can also ensure appropriate wettability to non-ink-absorbing and low-ink-absorbing recording media.

### 13. Method of Producing Ink Composition

The ink composition according to the embodiment can be prepared by mixing the above-described materials in an appropriate order and removing impurities by, for example, filtration, as necessary. In the production of the ink composition, it is preferred to uniformly disperse a coloring material in an aqueous solvent in advance and then mix the dispersion with other components, because of the easiness of handling.

The materials are preferably mixed by sequentially adding each of the materials to a container equipped with a stirring device such as a mechanical stirrer or a magnetic stirrer, and stirring the mixture. The filtration can be optionally performed by, for example, centrifugal filtration or filter filtration.

### 14. Ink Jet Recording Method

The ink jet recording method according to the embodiment includes a first step of forming an image by discharging droplets of the above-described ink composition onto a recording medium and a second step of drying the ink composition on the recording medium by heating the recording medium during and/or after the first step. Each step will now be described in detail.

### 14-1. First Step

The first step in the ink jet recording method according to the embodiment is a step of forming an image by discharging droplets of the ink composition onto a recording medium by an ink jet recording system.

The ink jet recording system can be any system that discharges the above-described ink composition as droplets from fine nozzles to allow the droplets to adhere to a recording medium. Examples of the ink jet recording system include the following four systems.

A first system is an electrostatic aspiration system. In this system, the recording is performed by applying a strong electric field between a nozzle and an acceleration electrode placed in front of the nozzle, continuously ejecting ink droplets from the nozzle, and supplying a printing information signal to deflection electrodes while the ink droplets are traveling between the deflection electrodes; or by ejecting ink droplets corresponding to a printing information signal without deflecting the ink droplets.

A second system is a system of forcefully ejecting ink droplets by applying a pressure to an ink solution with a small-sized pump and mechanically vibrating a nozzle with, for example, a quartz oscillator. In this system, the recording is performed by ejecting ink droplets and electrically charging the ejected ink droplets simultaneously with the ejection, and supplying a printing information signal to deflection electrodes while the ink droplets are traveling between the deflection electrodes.

A third system is a system using a piezoelectric element. In this system, the recording is performed by simultaneously applying a pressure and a printing information signal to an ink solution with the piezoelectric element and ejecting ink droplets.

A fourth system is a system of sharply expanding the volume of an ink solution by an effect of thermal energy. In this system, the recording is performed by heating the ink solution with a microelectrode according to a printing information signal to form foam and ejecting ink droplets by means of the foam.

### 14-2. Second Step

The second step in the ink jet recording method according to the embodiment is a step for drying the ink composition on the recording medium during and/or after the first step. By employing the second step, the liquid solvents contained in the ink composition adhering onto the recording medium partially or completely evaporate and scatter rapidly to form a coating of the first polymer particles having an average particle diameter of 200 nm or more and a heat distortion temperature of less than 100° C. contained in the ink composition. Consequently, a high-quality image having less uneven density defects can be formed within a short period of time even on a non-ink-absorbing recording medium such as a plastic film not having an ink-absorbing layer. In addition, the formation of the resin coating allows the dried ink to adhere onto the recording medium and thereby the image to be fixed.

The second step may be performed by any method that can accelerate evaporation and scattering of the liquid solvents contained in the ink composition. Examples of the method used as the second step include a method by applying a heat to the recording medium during and/or after the first step; a method by blowing air toward the ink composition on the recording medium after the first step; and a method of performing both the methods. Specifically, for example, forced-air heating, radiation heating, conduction heating, high-frequency drying, or microwave drying is preferably performed.

The heating in the second step may be performed at any temperature that accelerates evaporation and scattering of the liquid solvents contained in the ink composition. A temperature of 40° C. or more can achieve the effect, and the temperature range is preferably 40 to 90° C., more preferably 40 to 80° C. A temperature of higher than 100° C. may cause defects such as deformation in some types of recording media to cause difficulties in transporting of the recording media after the second step or may cause defects such as shrinkage when the recording media are cooled to room temperature.

The heating in the second step may be continued for any length of time that allows evaporation and scattering of the liquid solvents contained in the ink composition and formation of a coating of the polymer particles. The heating period can be appropriately set in consideration with the types of liquid solvents and the resin particles and the printing rate employed in the ink jet recording method.

### 15. Non-Ink-Absorbing or Low-Ink-Absorbing Recording Medium

Any recording medium can be used according to requirement. In the ink jet recording method according to the embodiment, in particular, non-ink-absorbing or low-ink-absorbing recording media, in addition to plain paper, can be suitably used. Throughout the specification, the term “non-ink-absorbing or low-ink-absorbing recording medium” refers to a “recording medium that absorbs 10 mL/m² or less water for 30 msec^{1/2} from the start of contact with water, in measurement by a Bristow method”. The Bristow method is most commonly used as a method for measuring the amount of liquid absorbed in a short period of time and is also employed by Japan Technical Association of the Pulp and Paper Industry (JAPAN TAPPI). The details of the test method are described in Standard No. 51 “Paper and Paperboard—Liquid Absorbency Test Method—Bristow Method” in “JAPAN TAPPI Paper and Pulp Test Methods, 2000 Edition”.

Examples of the non-ink-absorbing recording medium include plastic films not subjected to surface treatment for ink jet printing (i.e., not having an ink absorbing layer) and base materials, such as paper, provided with plastic coatings or plastic films thereon. Examples of the plastic used herein include polyvinyl chloride, polyethylene terephthalate, polycarbonate, polystyrene, polyurethane, polyethylene, and polypropylene. Examples of the low-ink-absorbing recording medium include printing paper such as art paper, coated paper, and mat paper. Examples of the ink-absorbing recording medium include high-quality paper, plain paper, and recycled paper.

### EXAMPLES

The invention will be described in detail by Examples below, but is not limited to these Examples at all.

### 16. Preparation of Ink Composition

### 16-1. Preparation of Pigment Dispersion

A pigment dispersion used in Examples was prepared as follows: A mixture of 65 parts by mass of Color Black S170 (trade name, carbon black (C.I. Pigment Black 7 (PBk7)), manufactured by Degussa-Huls AG), 35 parts by mass of Joncryl 611 (trade name, styrene-acrylic acid dispersion resin, manufactured by BASF Japan Corp.), 1.70 parts by mass of potassium hydroxide, and 250 parts by mass of ultrapure water purified by an ion-exchange method and a reverse osmotic method was subjected to dispersion in a ball mill using zirconia beads for 10 hours. The resulting undiluted dispersion was filtered through a glass fiber filter GA-100 (trade name, manufactured by Advantec Toyo Kaisha Ltd.) to remove coarse particles, and the pigment concentration was adjusted to 15% by mass.

The particle size distribution of the resulting pigment dispersion was measured with a Microtrac UPA150 (manufactured by manufactured by Microtrac) to confirm that the pigment had an average particle diameter of 117 nm.

### 16-2. Preparation of Ink Composition

Black ink compositions having different material compositions were prepared so as to have material compositions shown in Tables 3 to 5 using the pigment dispersion prepared above. Each ink composition was prepared by placing the materials shown in Tables 3 to 5 in a container, stirring the materials with a magnetic stirrer for 2 hours, and then removing coarse particles and impurities such as foreign matter by filtration through a membrane filter with a pore diameter of 10 μm. Note that the numerical values shown in Tables 3 to 5 all represent % by mass and that the total amount of the ink was adjusted to 100% by mass with deionized water. The types of surfactants are shown in Table 2.

TABLE 2

| | Solubility in | | | | | | |
|---|---|---|---|---|---|---|---|
| Surfactant | water | HLB | Surfactant 1 | Surfactant 2 | Surfactant 3 | Surfactant 4 | Surfactant 5 |
| KF-945 | Lipophilic | 4 | 30 | | | | |
| FZ-2123 | Lipophilic | 8 | | 30 | | | |
| KF-6013 | Hydrophilic | 10 | 70 | | | | |
| KF-354L | Hydrophilic | 16 | | 70 | 100 | | |
| Surfynol | Lipophilic | 4 | | | | 50 | |
| 420 | | | | | | | |
| Surfynol | Hydrophilic | 17 | | | | 50 | |
| 485 | | | | | | | |
| BYK 348 | — | — | | | | | 100 |
| Total | | | 100 | 100 | 100 | 100 | 100 |

KF-945: polysiloxane surfactant manufactured by Shin-Etsu Chemicals Co., Ltd.
FZ-2123: polysiloxane surfactant manufactured by Dow-Toray Corning Co., Ltd.
KF-6013: polysiloxane surfactant manufactured by Shin-Etsu Chemicals Co., Ltd.
KF-354L: polysiloxane surfactant manufactured by Shin-Etsu Chemicals Co., Ltd.
Surfynol 420: acetylene glycol surfactant manufactured by Air Products and Chemicals, Inc.
Surfynol 485: acetylene glycol surfactant manufactured by Air Products and Chemicals, Inc.
BYK 348: polysiloxane surfactant manufactured by BYK-Chemie Japan, Inc.

TABLE 3

| | | Example | | | | Comparative Example | | | |
|---|---|---|---|---|---|---|---|---|---|
| | | 1 | 2 | 3 | 4 | 1 | 2 | 3 | 4 |
| Dispersion | PBk7 (solid) | 4 | 4 | 4 | 4 | 4 | 4 | 4 | 4 |
| Resin | StAc-EM | 1 | 1 | 1 | 1 | 1 | 1 | 1 | 1 |
| Surfactant | Surfactant 1 in Table 2 | 0.5 | | 0.5 | | | | 0.5 | |
| | Surfactant 2 in Table 2 | | 0.5 | | 0.5 | | | | |
| | Surfactant 3 in Table 2 | | | | | 0.5 | | | |
| | Surfactant 4 in Table 2 | | | | | | 0.5 | | |
| | Surfactant 5 in Table 2 | | | | | | | | 0.5 |
| Alkyl polyols | PG (boiling point: 188° C.) | 15 | | | | 15 | 15 | | |
| | 12BD | | 15 | | | | | | |
| | 12PD | | | 15 | | | | | |
| | 12HD | 5 | 5 | 5 | 5 | 5 | 5 | 5 | 5 |
| | 3Me13BD | | | | 15 | | | | 13 |
| | Gly | | | | | | | 15 | |
| Glycol ether | EHDG (HLB value: 5.8) | 1 | | — | — | 1 | 1 | | |
| | EHG (HLB value: 5.4) | | 1 | — | — | | | | 1 |
| | BTG | | | | | | | 1 | |
| Pyrrolidone derivative | 2-Pyrrolidone | | | | | | | | |
| pH adjuster | TEA | 1 | 1 | 1 | 1 | 1 | 1 | 1 | 1 |
| | Pure water | Residual | Residual | Residual | Residual | Residual | Residual | Residual | Residual |
| | | quantity | quantity | quantity | quantity | quantity | quantity | quantity | quantity |
| Total | | 100 | 100 | 100 | 100 | 100 | 100 | 100 | 100 |
| Uneven density defect | High-quality paper | A | A | A | A | B | B | B | B |
| | Printing paper | A | A | A | A | B | B | B | B |
| | PET film | A | A | A | A | C | C | C | C |
| | PP film | A | A | B | B | C | C | C | C |
| | PVC | A | A | B | B | C | C | C | C |
| Ink storage stability | Change in viscosity | A | A | A | A | A | A | A | A |
| | Change in ink component | A | A | A | A | A | A | A | A |
| Recovery from clogging | | A | A | A | A | A | A | A | A |
| Fixability | | A | A | A | A | A | A | C | A |

TABLE 4

| | | | | | | | | | Comparative |
|---|---|---|---|---|---|---|---|---|---|
| | | Example | | | | | | | Example |
| | | 5 | 6 | 7 | 8 | 9 | 10 | 11 | 5 |
| Dispersion | PBk7 (solid) | 4 | 4 | 4 | 4 | 4 | 4 | 4 | 4 |
| Resin | StAc-EM | 1 | 1 | 1 | 1 | 1 | 1 | 1 | 1 |
| Surfactant | Surfactant A | 0.5 | | | | 0.5 | 0.5 | 0.5 | 0.5 |
| | Surfactant B | | 0.5 | | | | | | |
| | Surfactant C | | | 0.5 | | | | | |
| | Surfactant D | | | | 0.5 | | | | |
| Alkyl polyols | PG (boiling point: | 15 | 15 | 15 | 15 | | | | |
| | 188° C.) | | | | | | | | |
| | 12BD | | | | | 15 | | | |
| | 12PD | | | | | | 15 | | |
| | 12HD | 5 | 5 | 5 | 5 | 5 | 5 | 5 | 5 |
| | 3Me13BD | | | | | | | 15 | |
| | Gly | | | | | | | | 15 |
| Glycol ether | EHDG | 1 | 1 | 1 | 1 | 1 | 1 | 1 | 1 |
| | EHG | | | | | | | | |
| | BTG | | | | | | | | |
| Pyrrolidone derivative | 2-Pyrrolidone | | | | | | | | |
| pH adjuster | TEA | 1 | 1 | 1 | 1 | 1 | 1 | 1 | 1 |
| | Pure water | Residual | Residual | Residual | Residual | Residual | Residual | Residual | Residual |
| | | quantity | quantity | quantity | quantity | quantity | quantity | quantity | quantity |
| Total | | 100 | 100 | 100 | 100 | 100 | 100 | 100 | 100 |
| Uneven density defect | High-quality paper | A | A | A | A | A | A | A | B |
| | Printing paper | A | A | A | A | A | A | A | B |
| | PET film | A | A | A | A | A | A | A | C |
| | PP film | A | A | A | A | A | A | A | C |
| | PVC | A | A | A | A | A | A | A | C |
| Ink storage stability | Change in viscosity | A | A | A | A | A | A | A | A |
| | Change in ink component | A | A | A | A | A | A | A | A |
| Recovery from clogging | | A | A | A | A | A | A | A | A |
| Fixability | | A | A | A | A | A | A | A | A |

TABLE 5

| | | Example | | | | | | | |
|---|---|---|---|---|---|---|---|---|---|
| | | 12 | 13 | 14 | 15 | 16 | 17 | 18 | 19 |
| Dispersion | PBk7 (solid) | 4 | | | | 4 | | | |
| | PY74 | | 4 | | | | 4 | | |
| | PR122 | | | 4 | | | | 4 | |
| | PB15:3 | | | | 4 | | | | 4 |
| Resin | StAc-EM | 1 | 1 | 1 | 1 | 1 | 1 | 1 | 1 |
| Surfactant | Surfactant 1 in Table 2 | 0.5 | 0.5 | 0.5 | 0.5 | | | | |
| | Surfactant A | | | | | 0.5 | 0.5 | 0.5 | 0.5 |
| Alkyl polyols | PG (boiling point: 188° C.) | 15 | 15 | 15 | 15 | 15 | 15 | 15 | 15 |
| | 12BD | | | | | | | | |
| | 12PD | | | | | | | | |
| | 12HD | 5 | 5 | 5 | 5 | 5 | 5 | 5 | 5 |
| | 3Me13BD | | | | | | | | |
| | Gly | | | | | | | | |
| Glycol ether | EHDG | 1 | 1 | | | 1 | 1 | | |
| | EHG | | | 1 | 1 | | | 1 | 1 |
| | BTG | | | | | | | | |
| Pyrrolidone derivative | 2-Pyrrolidone | 1 | | | | 1 | | | |
| pH adjuster | TEA | 1 | 1 | 1 | 1 | 1 | 1 | 1 | 1 |
| | Pure water | Residual | Residual | Residual | Residual | Residual | Residual | Residual | Residual |
| | | quantity | quantity | quantity | quantity | quantity | quantity | quantity | quantity |
| Total | | 100 | 100 | 100 | 100 | 100 | 100 | 100 | 100 |
| Uneven density defect | High-quality paper | A | A | A | A | A | A | A | A |
| | Printing paper | A | A | A | A | A | A | A | A |
| | PET film | A | A | A | A | A | A | A | A |
| | PP film | A | A | A | A | A | A | A | A |
| | PVC | AA | A | A | A | AA | A | A | A |
| Ink storage stability | Change in viscosity | A | A | A | A | A | A | A | A |
| | Change in ink component | A | A | A | A | A | A | A | A |
| Recovery from clogging | | A | A | A | A | A | A | A | A |
| Fixability | | A | A | A | A | A | A | A | A |

Similarly, a yellow ink (Pigment Yellow 74), a cyan ink (Pigment Blue 15:3), and a magenta ink (Pigment Red 122) were prepared. In Tables 3 to 5, the materials identified by abbreviations are as follows:

StAc-EM: styrene acrylate copolymer resin emulsion;

PG: propylene glycol;

12BD: 1,2-butanediol;

12PD: 1,2-pentanediol;

12HD: 1,2-hexanediol;

3Me13BD: 3-methyl-1,3-butanediol;

Gly: glycerin;

EHDG: diethylene glycol mono-2-ethylhexyl ether;

EHG: ethylene glycol mono-2-ethylhexyl ether;

BTG: triethylene glycol monobutyl ether;

TEA: triethanolamine;

PVC: polyvinyl chloride; and

PP: polypropylene.

In Table 2, the materials identified by trade names are as follows:

KF-945: polysiloxane surfactant manufactured by Shin-Etsu Chemicals Co., Ltd.;

FZ-2123: polysiloxane surfactant manufactured by Dow-Toray Corning Co., Ltd.;

KF-6013: polysiloxane surfactant manufactured by Shin-Etsu Chemicals Co., Ltd.;

KF-354L: polysiloxane surfactant manufactured by Shin-Etsu Chemicals Co., Ltd.;

Surfynol 420: acetylene glycol surfactant manufactured by Air Products and Chemicals, Inc.;

Surfynol 485: acetylene glycol surfactant manufactured by Air Products and Chemicals, Inc.; and

BYK 348: polysiloxane surfactant manufactured by BYK-Chemie Japan, Inc.

In Tables 4 and 5, surfactant A is a polysiloxane surfactant and is prepared by mixing a compound represented by Formula (1) wherein R is a methyl group, a is an integer of 9 to 13, m is an integer of 2 to 4, and n is an integer of 1 or 2 and a compound represented by Formula (1) wherein R is a hydrogen atom, a is an integer of 7 to 11, m is an integer of 30 to 50, and n is an integer of 3 to 5 at a ratio of 3:7.

Surfactant B is a polysiloxane surfactant and is prepared by mixing a compound represented by Formula (1) wherein R is a methyl group, a is an integer of 9 to 13, m is an integer of 2 to 4, and n is an integer of 1 or 2 and a compound represented by Formula (1) wherein R is a hydrogen atom, a is an integer of 7 to 11, m is an integer of 30 to 50, and n is an integer of 3 to 5 at a ratio of 1:9.

Surfactant C is a mixture of polysiloxane surfactant AW-3 (manufactured by Shin-Etsu Chemicals Co., Ltd.) and polysiloxane surfactant X-22-6551 (manufactured by Shin-Etsu Chemicals Co., Ltd.) at a mass ratio of 9:1.

Surfactant D is a polysiloxane surfactant represented by Formula (1) wherein R is a methyl group, a is an integer of 9 to 13, m is an integer of 2 to 4, and n is an integer of 1 or 2.

### 17. Evaluation of Ink Composition

### Evaluation 1. Evaluation of Uneven Density Defects of Recorded Matter

As recording media, ink-absorbing high-quality paper (trade name: “55PW8R”, manufactured by Lintec Corp.), low-ink-absorbing printing paper (trade name: “POD Gloss Coat”, manufactured by Oji Paper Co., Ltd.), and a non-ink-absorbing polypropylene film (trade name: “SY51M 2.6 mil. PP White TC RP37 2.2 mil. HIGH DENSITY WHITE”, manufactured by UPM Raflata OY, hereinafter referred to as “SY51M”) were used. As the printer of an ink jet recording system, an ink jet printer (trade name: “PX-G930”, manufactured by Seiko Epson Corp., nozzle resolution: 180 dpi) equipped with a temperature variable heater at the paper guiding portion was used.

The ink jet printer was filled with any of the ink compositions, and an image was recorded on any of the recording media. A solid image pattern was recorded at a resolution of 720 dpi in the lateral direction and 720 dpi in the vertical direction with a duty in the range of 50 to 100% at 10% intervals. The recording conditions of the heater of the printer were set to “40° C. at the recording surface”. Drying treatment was performed by blowing air with a temperature of 80° C. to each recorded matter during and immediately after the recording. The blowing strength at the recording medium surface was set to a wind velocity of about 2 to 5 m/sec. The blowing immediately after recording was performed for 1 minute. The recorded matter formed under such conditions was visually inspected for uneven density defects. The evaluation criteria are as follows:

A: no uneven density defects are observed even at a duty of 80% or more,

B: no uneven density defects are observed until a duty of 70%,

C: no uneven density defects are observed until a duty of 60%, and

D: uneven density defects are observed even at a duty of 60% or less.

### Evaluation 2. Storage Stability of Ink Composition

Each ink composition shown in Tables 3 to 5 was sealed in a sample bottle and was left to stand under the environment of a temperature of 60° C. for 2 weeks. After the leaving to stand, each ink composition was evaluated for storage stability by observing change in viscosity of the ink. The evaluation results are shown in Tables 3 to 5. The evaluation criteria are as follows:

Change in Viscosity

A: quantity of a change in viscosity from that immediately after the preparation is less than ±5%,

B: quantity of a change in viscosity from that immediately after the preparation is ±5% or more but less than ±10%,

C: quantity of a change in viscosity from that immediately after the preparation is ±10% or more but less than ±20%, and

D: quantity of a change in viscosity from that immediately after the preparation is ±20% or more.

### Evaluation 3. Clogging of Head

The head of an ink jet recording system, an ink jet printer (trade name: “PX-G930”, manufactured by Seiko Epson Corp., nozzle resolution: 180 dpi), was filled with any of the ink compositions shown in Tables 3 to 5. Subsequently, a nozzle check pattern was printed for confirmation of no filling defect and nozzle clogging, and the printer head was left to stand in an uncapped state (i.e., a state for accelerating drying of head nozzle face) under the environment of 25° C./40 to 60% RH for one week. Subsequently, cleaning operation was optionally performed, and then a nozzle check pattern was printed. Clogging of the ink jet head with the ink composition was evaluated by observing discharging conditions of the nozzles. The evaluation results are shown in Tables 3 to 5. The evaluation criteria are as follows:

A: all nozzles normally discharge an ink composition after repeating the cleaning operation 3 or less times,

B: all nozzles normally discharge an ink composition after repeating the cleaning operation 4 to 6 times,

C: all nozzles normally discharge an ink composition after repeating the cleaning operation 7 to 10 times, and

D: all nozzles normally discharge an ink composition after repeating the cleaning operation 11 or more times, or any of nozzles does not normally discharge an ink composition even after repeating the cleaning operation 11 or more times.

### Evaluation 4. Fixability

After printing as in evaluation 1, the recorded matter was left to stand in the laboratory under conditions of room temperature (25° C.) for 5 hours, and the surface of the recorded matter was rubbed with a cotton cloth 10 times under a load of 200 g with a Gakushin-type rubbing fastness tester (trade name: “AB-301”, manufactured by Tester Sangyo Co., Ltd.). Fixability was evaluated by observing conditions of detachment of the recorded surface and of ink transfer to the cotton cloth. The evaluation results are shown in Tables 3 to 5. The evaluation criteria are as follows:

A: no ink detachment and ink transfer to the cotton cloth are observed after rubbing 10 times,

B: ink detachment or ink transfer to the cotton cloth is observed after rubbing 10 times, and

C: ink detachment or ink transfer to the cotton cloth is observed before the completion of rubbing 10 times.

What is claimed is:

1. An ink composition comprising:
a coloring material;
two or more polysiloxane surfactants having different solubilities in water; and
an alkyl polyol having a boiling point at one atmosphere of 180 to 230° C.,
wherein the ink composition does not substantially contain an alkyl polyol having a boiling point at one atmosphere of 280° C. or more and enables recording on a non-ink-absorbing or low-ink-absorbing recording medium.

2. The ink composition according to claim 1, wherein
the polysiloxane surfactants include a lipophilic polysiloxane surfactant (a) having an HLB value of 4 to 8 or represented by the following Formula (1) having R being a methyl group and a hydrophilic polysiloxane surfactant (b) having an HLB value of 9 to 20 or represented by the following Formula (1) having R being a hydrogen atom: 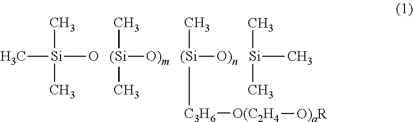
(wherein, R represents a hydrogen atom or a methyl group; a represents an integer of 2 to 13; m represents an integer of 0 or more; and n represents an integer of 1 to 5).

3. The ink composition according to claim 2, wherein the mass ratio of the lipophilic polysiloxane surfactant content to the hydrophilic polysiloxane surfactant content in the ink composition is 1/20 or more and 2/1 or less.

4. The ink composition according to claim 2, wherein the content of the hydrophilic polysiloxane surfactant is higher than that of the lipophilic polysiloxane surfactant in the ink composition.

5. The ink composition according to claim 1, further comprising a glycol ether having an HLB value calculated by a Davies' method in a range of 4.2 to 8.0.

6. The ink composition according to claim 5, wherein
the alkyl polyol is C4-7 1,2-straight-chain alkyl diol, and the mass ratio of the C4-7 1,2-straight-chain alkyl diol to the glycol ether is higher than 1/1 and 20/1 or less.

7. An ink jet recording method using the ink composition according to claim 1.

8. An ink jet recording method using the ink composition according to claim 2.

9. An ink jet recording method using the ink composition according to claim 3.

10. An ink jet recording method using the ink composition according to claim 4.

11. An ink jet recording method using the ink composition according to claim 5.

12. An ink jet recording method using the ink composition according to claim 6.

13. A recorded matter recorded by the ink jet recording method according to claim 7.

14. A recorded matter recorded by the ink jet recording method according to claim 8.

15. A recorded matter recorded by the ink jet recording method according to claim 9.

16. A recorded matter recorded by the ink jet recording method according to claim 10.

17. A recorded matter recorded by the ink jet recording method according to claim 11.

18. A recorded matter recorded by the ink jet recording method according to claim 12.
